(19) United States
(12) Patent Application Publication
(10) Pub. No.: US 2024/0201344 A1
(43) Pub. Date: Jun. 20, 2024

(54) SENSOR CLEANING DEVICE

(71) Applicants: HYUNDAI MOTOR COMPANY, Seoul (KR); KIA CORPORATION, Seoul (KR); NIFCO KOREA INC., Asan-si (KR); DY AUTO CORPORATION, Asan-si (KR)

(72) Inventors: Hyun Woo Yoon, Hwaseong-si (KR); Sung Min Yang, Incheon (KR); Jae Hyoung Kim, Asan-si (KR); Sin Won Kang, Asan-si (KR)

(73) Assignees: HYUNDAI MOTOR COMPANY, Seoul (KR); KIA CORPORATION, Seoul (KR); NIFCO KOREA INC., Asan-si (KR); DY AUTO CORPORATION, Asan-si (KR)

(21) Appl. No.: 18/132,742

(22) Filed: Apr. 10, 2023

(30) Foreign Application Priority Data
Dec. 14, 2022 (KR) 10-2022-0174373

(51) Int. Cl. G01S 7/497; B08B 5/02; B60S 1/54; G01S 17/931

(52) U.S. Cl. CPC G01S 7/497; B08B 5/02; B60S 1/54; G01S 17/931; G01S 2007/4977

(57) ABSTRACT

A sensor cleaning device includes a chamber portion disposed on the outer circumferential surface of a sensor and has an air passage and a discharge port formed therein. A blocking portion is coupled to the chamber portion to shield the discharge port and is configured to selectively open the discharge port by the injection pressure of injected air. A holder portion is coupled to the chamber portion while covering the blocking portion and is configured to control the opening displacement of the blocking portion when the blocking portion is opened.

### CROSS-REFERENCE TO RELATED APPLICATION

This application claims, under 35 U.S.C. § 119(a), the benefit of and priority to Korean Patent Application No. 10-2022-0174373, filed on Dec. 14, 2022, the entire contents of which are incorporated herein by reference.

### BACKGROUND

### (a) Technical Field

The present disclosure relates to a sensor cleaning device. More particularly, the present disclosure relates to a sensor cleaning device capable of preventing inflow of foreign matter into an air discharge port for cleaning.

### (b) Background Art

Generally, a cognitive sensor applied to a vehicle to implement self-driving is broadly classified into three types: a camera, a lidar, and a radar. Because self-driving level 3 requires functions such as autonomous parking as well as autonomous driving on highways, the need for a lidar sensor, among the three types of sensors, having high distance resolution is increasing.

Meanwhile, when the lidar sensor is installed inside a separate structure such as glass or a vehicle, the sensing performance thereof may be significantly reduced. For this reason, the lidar sensor is generally mounted on a front bumper and exposed to the outside environment.

The above-described deterioration in sensing performance may be prevented by mounting the lidar sensor to be exposed to the outside environment, but the surface of the sensor is inevitably exposed to contamination.

In order to prevent the problem of deteriorating the cognitive performance of the lidar sensor as described above, the surface of the sensor must be cleaned. Air and washer fluid are mainly used as normal working fluids for cleaning the surface of the sensor.

When air is used as the working fluid and the air is injected through a nozzle, it is common that a discharge port in the nozzle is directed downwards or sideways. This is because, when the discharge port faces upwards, it is very vulnerable to inflow of foreign matter and contaminants from outside the system.

However, there may be a case in which the discharge port in the nozzle faces upwards due to various restrictions such as the layout of the vehicle. In such a case, when the nozzle is located outside the vehicle as described above, foreign matter is unavoidably introduced through the discharge port.

The above information disclosed in this Background section is only to enhance understanding of the background of the disclosure. Therefore, the Background section may contain information that does not form the prior art that is already known person of ordinary skill in the art.

### SUMMARY OF THE DISCLOSURE

The present disclosure has been made in an effort to solve the above-described problems associated with the prior art. Objects of the present disclosure are to provide a lidar sensor cleaning device including first and second chambers. The first chamber has a passage for air for cleaning formed therein. The second chamber covers the first chamber and has a discharge port formed therein that is connected to the air passage. The second chamber is coupled to the first chamber and is provided with an elastic member configured to selectively open the discharge port only when air is injected. This prevents a problem of inflow of foreign matter into the open discharge port, thereby stably performing air injection and effectively cleaning the lidar sensor.

The objects of the present disclosure are not limited to the objects mentioned above. Other objects not mentioned herein should be clearly understood by those of ordinary skill in the art to which the present disclosure pertains based on the description below. The sensor cleaning device may also be applied to sensors and sensor types other than lidar sensors.

In one aspect, the present disclosure provides a sensor cleaning device. The cleaning device includes: a chamber portion configured to be disposed on the outer circumferential surface of a sensor and having an air passage and a discharge port formed therein; a blocking portion coupled to the chamber portion to shield the discharge port and configured to selectively open the discharge port by the injection pressure of injected air; and a holder portion coupled to the chamber portion while covering the blocking portion and configured to control the opening displacement of the blocking portion when the blocking portion is opened.

In an embodiment, the chamber portion may include a lower chamber including a plurality of mounting members configured to fix the cleaning device at a position where the cleaning device is disposed on the outer circumferential surface of the sensor and having an air inlet port formed therein. The chamber portion may also include an upper chamber coupled to the lower chamber defining the air passage therein and having the discharge port formed therein connected to the air passage.

In another embodiment, the lower chamber may include an inclined member defining the inner side of the air passage. The upper chamber may include a guide member defining the outer side of the air passage and may form the air passage therein inclined upwards from the air inlet port as the upper chamber is coupled to the lower chamber.

In still another embodiment, the lower chamber may protrude in a direction to be coupled to the upper chamber and may include a pair of fixation members configured to fix the lower chamber at a position at which the lower chamber is coupled to the upper chamber.

In yet another embodiment, the chamber portion may have a rounded or curved shape and may be provided in multiple parts coupled to one another to correspond to the shape of the outer circumferential surface of the sensor.

In still yet another embodiment, the blocking portion may include a fitting member inserted into a fitting groove disposed parallel to the discharge port. The blocking portion may also include a shielding member, coupled to the fitting member and extending in a horizontal direction, and configured to shield the discharge port when the fitting member is inserted into the fitting groove.

In a further embodiment, the shielding member may be made of an elastic material and allow a displacement of a front region thereof to be variable with respect to a guideline by the injection pressure of the air injected through the discharge port to thereby open the discharge port.

In another further embodiment, the holder portion may include a pair of coupling members inserted into a pair of insertion grooves disposed on the same line as the discharge port. The holder portion may also include a holder member interconnecting the coupling members, extending to be inclined upwards towards the blocking portion, and selectively brought into contact with the blocking member when the blocking member is opened.

In still another further embodiment, the holder portion may be provided in multiple parts and each part may have a different inclination angle. The holder portion or the multiple parts may be selectively replaced from the chamber portion.

In another aspect, the present disclosure provides a sensor cleaning device. The cleaning device includes a chamber portion configured to be disposed on an outer circumferential surface of a sensor. An air passage is formed by a lower chamber and an upper chamber coupled to each other. The cleaning device also includes a discharge port formed in the chamber portion connected to the air passage. The cleaning device further includes a blocking portion coupled to the chamber portion to shield the discharge port and configured to selectively open the discharge port by the injection pressure of injected air. The cleaning device also includes a holder portion coupled to the chamber portion while covering the blocking portion and configured to control the opening displacement of the blocking portion when the blocking portion is opened.

In another aspect, the present disclose provides a sensor and cleaning device assembly. The assembly includes a sensor having an outer circumferential surface and a sensor cleaning device. The sensor cleaning device includes: a chamber portion disposed on the outer circumferential surface of the sensor and having an air passage and a discharge port formed therein; a blocking portion coupled to the chamber portion to shield the discharge port and configured to selectively open the discharge port by an injection pressure of injected air; and a holder portion coupled to the chamber portion while covering the blocking portion and configured to control an opening displacement of the blocking portion when the blocking portion is opened.

In an aspect, the sensor may be a lidar sensor.

Other aspects and embodiments of the disclosure are discussed below.

It is to be understood that the term “vehicle” or “vehicular” or other similar terms as used herein are inclusive of motor vehicles in general. Such motor vehicles may encompass passenger automobiles including sport utility vehicles (SUV), buses, trucks, various commercial vehicles, watercraft including a variety of boats and ships, aircraft, and the like. Such motor vehicles may also include hybrid vehicles, electric vehicles, plug-in hybrid electric vehicles, hydrogen-powered vehicles, and other alternative fuel vehicles (e.g. fuels derived from resources other than petroleum). As referred to herein, a hybrid vehicle is a vehicle that has two or more sources of power, such as for example, a vehicle powered by both gasoline and electricity.

The above and other features of the disclosure are discussed below.

### BRIEF DESCRIPTION OF THE DRAWINGS

The above and other features of the present disclosure are described in detail with reference to certain embodiments thereof illustrated in the accompanying drawings, which are given hereinbelow by way of illustration only, and thus are not limitative of the present disclosure, and wherein:

FIG. 1 is a view illustrating a lidar sensor mounted to a lidar sensor cleaning device according to an embodiment of the present disclosure;

FIG. 2 is a view illustrating an assembled state of a lidar sensor cleaning device according to an embodiment of the present disclosure;

FIGS. 3 and 4 are views illustrating exploded views of a lidar sensor cleaning device (FIG. 3) and an enlarged view of a portion thereof (FIG. 4) according to an embodiment of the present disclosure;

FIG. 5 is an enlarged view illustrating an assembled state of the portion in FIG. 4 of a lidar sensor cleaning device according to an embodiment of the present disclosure;

FIG. 6 is a view illustrating air injection of a lidar sensor cleaning device according to an embodiment of the present disclosure;

FIGS. 7 and 8 are section views illustrating the operation of a blocking portion of a lidar sensor cleaning device according to an embodiment of the present disclosure; and

FIG. 9 is a view illustrating an open state of a blocking portion of a lidar sensor cleaning device according to an embodiment of the present disclosure.

It should be understood that the appended drawings are not necessarily drawn to scale, presenting a somewhat simplified representation of various features illustrative of the basic principles of the disclosure. The specific design features of the present disclosure as disclosed herein, including, for example, specific dimensions, orientations, locations, and shapes, may be determined in part by the particular intended application and usage environment.

In the figures, the same reference numbers refer to the same or equivalent parts of the present disclosure throughout the several figures of the drawings.

### DETAILED DESCRIPTION

A detailed description is now given according to embodiments disclosed herein with reference to the accompanying drawings.

Advantages and features of the present disclosure, and a method of achieving the same, should be apparent with reference to the embodiments described below in detail in conjunction with the accompanying drawings.

However, the embodiments of the present disclosure may be embodied in many different forms. Thus, the present disclosure should not be construed as being limited to the embodiments set forth herein. Rather, the embodiments are provided so that the present disclosure will be thorough and complete, and will fully convey the scope of the present disclosure to those having ordinary skill in the art. The present disclosure is defined and limited only by the categories and scope of the claims.

In describing the technical concepts of the present disclosure, if a detailed explanation of a related known function or construction was considered to unnecessarily obscure the gist of the present disclosure, such explanation has been omitted but would be understood by those having ordinary skill in the art.

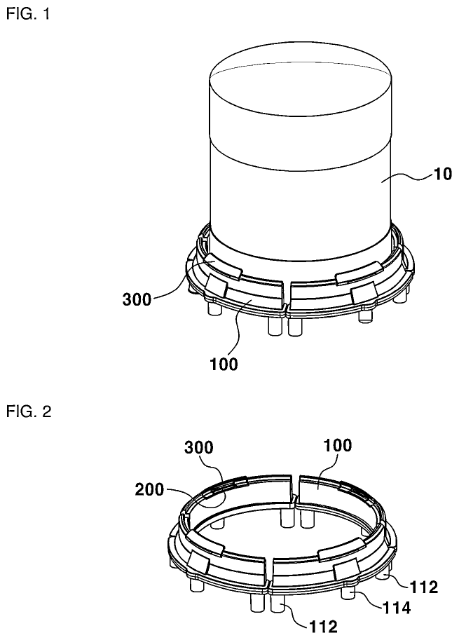

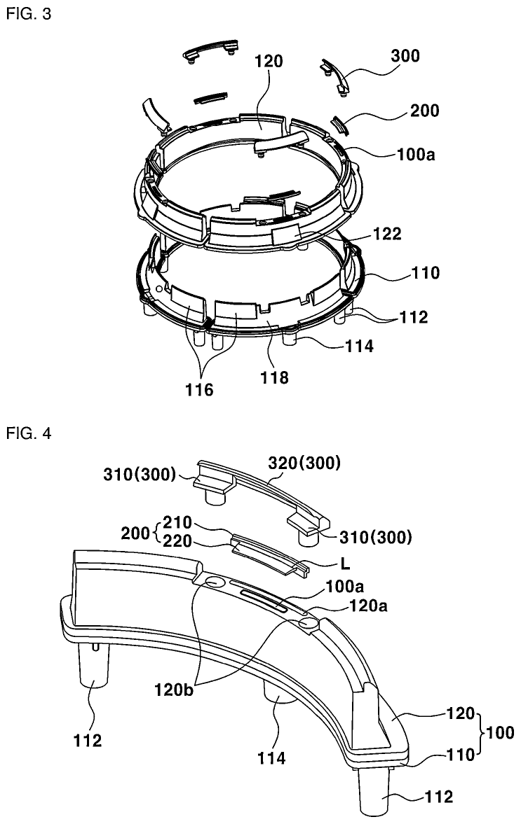

FIG. 1 is a view illustrating a lidar sensor mounted to a lidar sensor cleaning device according to an embodiment of the present disclosure. FIG. 2 is a view illustrating an assembled state of a lidar sensor cleaning device according to an embodiment of the present disclosure. FIGS. 3 and 4 are exploded views of a lidar sensor cleaning device according to an embodiment of the present disclosure.

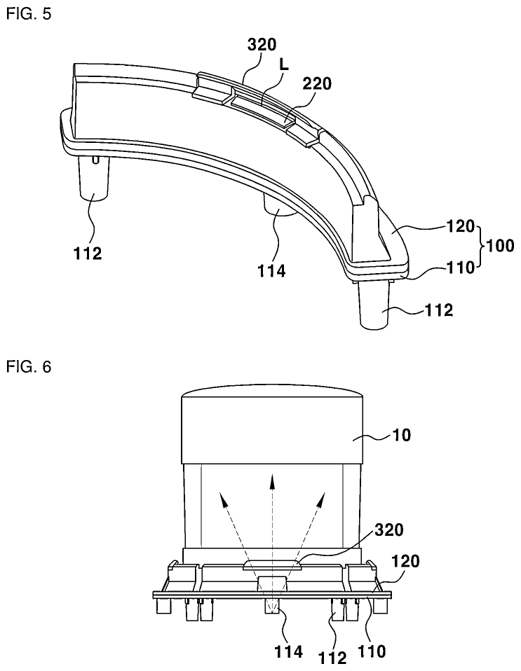

FIG. 5 is an enlarged view illustrating an assembled state of the portion in FIG. 4 of a lidar sensor cleaning device according to an embodiment of the present disclosure. FIG. 6 is a view illustrating air injection of a lidar sensor cleaning device according to an embodiment of the present disclosure.

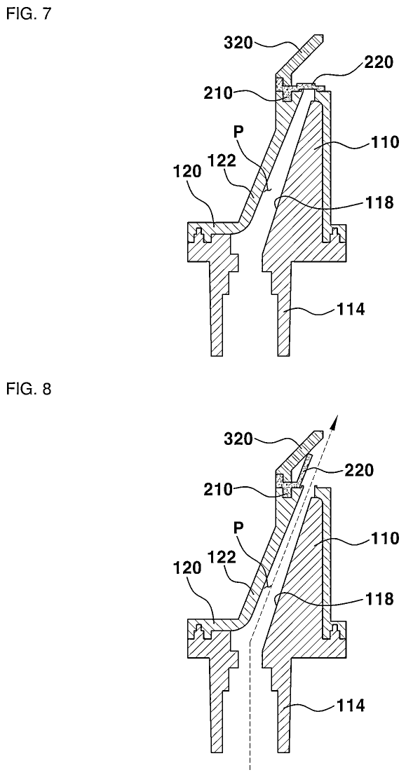

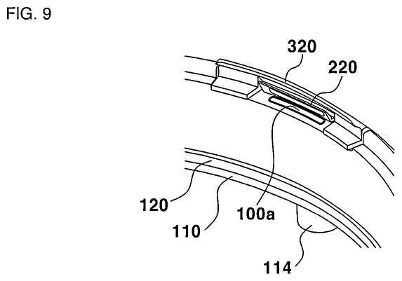

FIGS. 7 and 8 are section views illustrating the operation of a blocking portion of a lidar sensor cleaning device according to an embodiment of the present disclosure. FIG. 9 is a view illustrating an open state of a blocking portion of a lidar sensor cleaning device according to an embodiment of the present disclosure.

As illustrated in FIGS. 1-3, a lidar sensor cleaning device according to an embodiment includes a chamber portion 100, a blocking portion 200, and a holder portion 300.

The chamber portion 100 is disposed on the outer circumferential surface of a lidar sensor 10 and has an air passage P and a discharge port 100a formed therein.

Such a chamber portion 100 has a rounded or curved shape, and may be provided in plural, i.e., in multiple pieces or parts, which are coupled to one another such that the chamber portion 100 corresponds to the shape of the outer circumferential surface of the sensor 10. In the example shown, the lidar sensor 10 has a circular or cylindrical shape and the lidar sensor cleaning device thus corresponds to the shape of the circular lidar sensor as illustrated in FIG. 1.

Although the chamber portion 100 is illustrated in the drawing as having a structure in which four pieces or parts, i.e., chamber portions 100 are coupled to one another along the outer circumferential surface of the sensor 10, the structure applies to one embodiment and is not limited thereto. The number of pieces or parts forming the assembled chamber portion 100 and being coupled to one another may be one single part or may increase depending on the diameter and/or shape of the sensor 10.

In addition, the chamber portion 100 has the air passage P formed therein through which air used for cleaning flows. The chamber portion 100 may be applied for cleaning other sensors and sensor types, in addition to the lidar sensor. The chamber portion or portions 100 each may have a shape different from the rounded or curved shape to be connected to one another.

The chamber portion 100 includes a lower chamber 110 and an upper chamber 120.

The lower chamber 110 includes a plurality of mounting members 112 configured to fix the lidar sensor cleaning device at a position where the cleaning device is disposed on the outer circumferential surface of the sensor 10. The lower chamber 110 has an air inlet port 114 formed therein.

Here, the air inlet port 114 is disposed between the mounting members 112, which are provided at a corresponding one of the opposite ends of the lower chamber 110. Thus, the air inlet port 114 may be disposed in the center of the lower chamber 110 to extend to the air passage P and may be connected to a separate supply nozzle (not shown).

In addition, the lower chamber 110 may protrude in a direction to be coupled to the upper chamber 120 and may include a pair of fixation members 116 configured to fix the lower chamber 110 at a position at which the lower chamber 110 is coupled to the upper chamber 120.

In other words, the fixation members 116 are inserted into and engaged with the upper chamber 120 at a corresponding position when vertically coupled to the upper chamber 120 (see FIG. 3). Accordingly, when the rounded lower chamber 110 is coupled to the rounded upper chamber 120, the fixation members 116 prevent the upper chamber 120 from rotating with respect to the lower chamber 110, so that the coupled position may be effectively fixed.

As the upper chamber 120 is coupled to the lower chamber 110, the upper chamber 120 forms the air passage P and the discharge port 100a connected to the air passage P.

The upper chamber 120 includes a guide member 122 defining the outer side of the air passage. As the upper chamber 120 is coupled to the lower chamber 110, the upper chamber 120 forms the air passage P therein inclined upwards from the air inlet port 114.

More specifically, because the lower chamber 110 has an inclined member 118 defining the inner side of the air passage P and the upper chamber 120 has the guide member 122 facing the inclined member 118, the inner and outer sides of the inclined air passage P are defined as illustrated in FIGS. 7 and 8. Thus, air may be effectively supplied towards the sensor 10.

In other words, air supplied to the air passage P through the air inlet port 114 is injected in the direction of the arrow as illustrated in FIG. 6 to thereby perform cleaning within a predetermined range of washing. Here, because the air passage P is inclined towards the sensor 10 as described above, the air may be intensively injected towards the surface of the sensor 10.

Meanwhile, the blocking portion 200 may be coupled to the chamber portion 100 to shield the discharge port 100a and may selectively open the discharge port 100a by the injection pressure of the air injected.

To this end, as illustrated in FIG. 4, the blocking portion 200 includes a fitting member 210 and a shielding member 220.

The fitting member 210 is inserted into a fitting groove 120a disposed parallel to the discharge port 100a and has a length greater than the length of the discharge port 100a in the widthwise direction. The size and shape of the fitting members and the fitting grooves or holes are not limited to the disclosed examples.

The fitting member 210 may have a thickness greater than the fitting groove 120a and may be press-fitted into the fitting groove 120a to be fixed in the place.

In addition, because the shielding member 220 is integrated with the fitting member 210 and extends in a horizontal direction, the shielding member 220 shields the discharge port 100a as the fitting member 210 is inserted into the fitting groove 120a.

The shielding member 220 may be made of a material having elasticity and may selectively open the discharge port 100a.

More specifically, as illustrated in FIGS. 4 and 5, the shielding member 220 allows the displacement of the front region of the elastic shielding member 220 to be variable with respect to a guideline L by the injection pressure of the air injected through the discharge port 100a, thereby selectively opening the discharge port 100a.

Accordingly, as illustrated in FIG. 7, the shielding member 220 is in a state of shielding the discharge port 100a before cleaning of the sensor 10. When the air supplied through the air passage P flows and is injected to clean the sensor 10, the displacement is varied with respect to the guideline L by the injection pressure of the injected air, thereby opening the discharge port 100a as illustrated in FIGS. 8 and 9.

With this structure, the discharge port 100a is selectively opened by the injection pressure. Thus, the shielding member 220 shields the discharge port 100a before cleaning of the sensor 10 to prevent foreign matter from entering inside the lidar sensor cleaning device 10 through the discharge port.

Meanwhile, the holder portion 300 may be coupled to the chamber portion 100 while covering the blocking portion 200, i.e., the shielding member 220, and may control the opening displacement of the shielding member 220 when the shielding member 220 is opened by the air injection pressure.

The holder portion 300 includes a pair of coupling members 310 and a holder member 320.

Here, as illustrated in FIG. 4, the pair of coupling members 310 has a protruding shape and is inserted into a pair of insertion grooves 120b disposed on the same line as the discharge port 100a.

The coupling member 310 may have a diameter greater than the diameter of the insertion groove 120b, thereby being press-fitted into the insertion groove 120b to be fixed at the insertion position. The size and shape of the coupling members and the insertion grooves or holes are not limited to the disclosed examples.

The holder member 320 may interconnect the pair of coupling member 310 that are spaced apart from each other while structurally overlapping the fitting member 210. The fitting member 210 is thereby prevented from being separated from the fitting groove 120a and allowing the blocking portion 200 to be stably fixed to the chamber portion 100.

In addition, the holder member 320 extends to be inclined upwards towards the blocking portion 200 and is selectively brought into contact with the blocking member 220 when the blocking member 220 is opened.

In other words, referring to FIGS. 8 and 9, the holder member 320 has a predetermined inclination and extends circumferentially and thus is disposed to be spaced apart from the shielding member 220 in a state of shielding the discharge port 100a. When the discharge port 100a is opened by the injection pressure of the air and the opening displacement of the shielding member 220 varies, the holder member 320 is brought into contact with the shielding member 220 to control the opening displacement of the shielding member 220.

As described above, the holder member 320 serves to control the maximum degree or amount of the opening displacement of the shielding member 220. In addition, because the holder member 320 has a widthwise length greater than that of the blocking portion 200, when air is injected, the injection passage of the air has an inclination and extends from the air passage P. Thus, the holder member 320, together with the shielding member 220, may effectively guide the direction of the injected air.

Moreover, the holder portion 300 may also be provided in plural and each separate part may have the holder member 320 having different inclination angles. The holder portion 300 may be replaceable by separating the coupling member 310 from the insertion groove 120b. With this configuration, the injection passage extending from the air passage P may vary depending on the size of the sensor 10.

As is apparent from the above description, the present disclosure provides the following effects.

The present disclosure provides a lidar sensor cleaning device including a first chamber having a passage formed therein for air for cleaning and including a second chamber covering the first chamber and having a discharge port formed therein connected to the air passage. The second chamber is coupled to the first chamber and is provided with an elastic member configured to selectively open the discharge port only when air is injected. This prevents a problem of inflow of foreign matter or contaminants into the open discharge port, thereby stably performing air injection and effectively cleaning the lidar sensor.

In addition, the present disclosure provides an elastic member holder configured to control the displacement of the elastic member. Thus, the elastic member, when opened by the pressure of the injected air, extends the air passage to thereby allow the injection direction of air towards the lidar sensor to be kept constant.

Embodiments of the present disclosure have been described with reference to the accompanying drawings. However, those having ordinary skill in the art to which the present disclosure pertains should understand that various modifications may be made and that all or part of the above-described embodiment(s) may be selectively combined. Therefore, the true scope of protection of the present disclosure should be determined by the technical ideas of the appended claims.

What is claimed is:

1. A sensor cleaning device, the device comprising:
a chamber portion configured to be disposed on an outer circumferential surface of a sensor and having an air passage and a discharge port formed therein;
a blocking portion coupled to the chamber portion to shield the discharge port and configured to selectively open the discharge port by an injection pressure of injected air; and
a holder portion coupled to the chamber portion while covering the blocking portion and configured to control an opening displacement of the blocking portion when the blocking portion is opened.

2. The device according to claim 1, wherein the chamber portion comprises:
a lower chamber having a plurality of mounting members configured to fix the device at a position where the device is disposed on the outer circumferential surface of the sensor and having an air inlet port formed therein; and
an upper chamber coupled to the lower chamber to form the air passage therein and having the discharge port formed therein connected to the air passage.

3. The device according to claim 2, wherein:
the lower chamber comprises an inclined member defining an inner side of the air passage, and
the upper chamber comprises a guide member defining an outer side of the air passage, the air passage being formed therein inclined upwards from the air inlet port.

4. The device according to claim 2, wherein the lower chamber protrudes in a direction to be coupled to the upper chamber and comprises a pair of fixation members configured to fix the lower chamber at a position at which the lower chamber is coupled to the upper chamber.

5. The device according to claim 1, wherein the chamber portion has a curved shape and is provided in multiple parts coupled to one another to correspond to a shape of the outer circumferential surface of the sensor.

6. The device according to claim 1, wherein the blocking portion comprises:
a fitting member inserted into a fitting groove disposed parallel to the discharge port; and
a shielding member coupled to the fitting member, extending in a horizontal direction, and configured to shield the discharge port when the fitting member is inserted into the fitting groove.

7. The device according to claim 6, wherein the shielding member allows a displacement of a front region thereof to be variable with respect to a guideline by the injection pressure of the air injected through the discharge port to thereby open the discharge port.

8. The device according to claim 7, wherein the shielding member is made of an elastic material.

9. The device according to claim 1, wherein the holder portion comprises:
a pair of coupling members inserted into a pair of insertion grooves disposed on a same line as the discharge port; and
a holder member, interconnecting the coupling members, extending to be inclined upwards towards the blocking portion, and selectively brought into contact with the blocking member when the blocking member is opened.

10. The device according to claim 9, wherein the holder portion is provided in multiple parts and each part has the holder member having different inclination angles, and wherein the holder portion or each part is selectively replaceable from the chamber portion.

11. A sensor cleaning device, the device comprising:
a chamber portion, configured to be disposed on an outer circumferential surface of a sensor, forming an air passage defined by a lower chamber and an upper chamber coupled to each other, and having a discharge port formed therein connected to the air passage;
a blocking portion coupled to the chamber portion to shield the discharge port and configured to selectively open the discharge port by an injection pressure of injected air; and
a holder portion coupled to the chamber portion while covering the blocking portion and configured to control an opening displacement of the blocking portion when the blocking portion is opened.

12. A sensor and cleaning device assembly, the assembly comprising:
a sensor having an outer circumferential surface; and
a sensor cleaning device including
a chamber portion disposed on the outer circumferential surface of the sensor and having an air passage and a discharge port formed therein;
a blocking portion coupled to the chamber portion to shield the discharge port and configured to selectively open the discharge port by an injection pressure of injected air; and
a holder portion coupled to the chamber portion while covering the blocking portion and configured to control an opening displacement of the blocking portion when the blocking portion is opened.

13. The assembly according to claim 12, wherein the sensor is a lidar sensor.
